(19) United States
(12) Patent Application Publication
(10) Pub. No.: US 2002/0158841 A1
(43) Pub. Date: Oct. 31, 2002

(54) Coordinate input device having strain gauges capable of being surface-mounted without flux cleaning

(75) Inventors: Shinji Hirano, Fukushima-ken (JP); Junichi Inamura, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/133,457

(22) Filed: Apr. 26, 2002

(30) Foreign Application Priority Data
Apr. 27, 2001 (JP) 2001-131304

(51) Int. Cl. G09G 5/00; G09G 5/08

(52) U.S. Cl. 345/156; 345/160

(57) ABSTRACT

A coordinate input device includes a flat substrate portion, a plurality of strain gauges formed on one surface of the substrate portion, an operating portion disposed at about the center of the other surface of the substrate portion, and a printed board on which one surface of the substrate portion is mounted. Since a portion of the printed board opposing the strain gauges has a through hole, it is thereby opened. Therefore, even when the substrate portion is bent by tilting the operating portion, the strain gauges will not touch the printed board. Accordingly, it is possible to omit flux cleaning, to shorten the assembly time, and to reduce the cost.

### BACKGROUND OF THE INVENTION

1. Field of the Invention

The present invention relates to a surface-mountable coordinate input device having strain gauges for use in computers and the like.

2. Description of the Related Art

A coordinate input device proposed before will be described with reference to FIG. 13. In the coordinate input device, a plurality of wiring patterns (not shown) are formed on the surface of a printed board 51.

Land portions 51a for soldering are formed on some positions of the wiring patterns. A control member 52 is soldered to the land portions 51a.

The wiring patterns except for any land portions 51a are covered with a resist film having a predetermined thickness.

The control member 52 includes a flat and rectangular substrate portion 53, and a plurality of (four) strain gauges 53a formed on one surface of the substrate portion 53 opposing the printed board 51.

The strain gauges 53a are formed of a resistor, and are placed on the diagonal lines of the substrate portion 53 so that they are equally spaced 90°.

Patterns (not shown) extend from the strain gauges 53a, and are soldered to the land portions 51a of the printed board 51. An operating portion 54 shaped like a quadrangular column is bonded to the center of the other surface of the substrate portion 53 with an adhesive or the like.

In order to assemble the above known coordinate input device, solder cream is applied to the land portions 51a of the printed board 51, and the control member 52 is placed thereon with the patterns formed on one surface of the substrate portion 53 with the land portions 51a.

When the printed board 51 having the control member 52 placed thereon is passed through a high-temperature soldering furnace, the control member 52 is surface-mounted on the printed board 51, and the coordinate input device is assembled.

By applying an operating load in the horizontal direction shown by arrow A, the control member 54 is tilted, and the substrate portion 53 is bent in response thereto.

The resistance of each of the strain gauges 53a made of a resistor is changed by the bending of the substrate portion 53, and a change in resistance is output.

Then, a control section (not shown) detects the amount of changes in resistance output from a plurality of (four) strain gauges 53a, and controls, for example, the movement of a cursor on the display of a personal computer or the like in accordance with the amount of change in resistance.

Since the distance between the printed board 51 and the strain gauges 53a is small, approximately 0.1 mm, in the above coordinate input device, flux flows into the space between the printed board 51 and the strain gauges 53a when the control member 52 is soldered to the printed board 51.

The flux flowing between the printed board 51 and the strain gauges 53a sets into a clay form when the temperature decreases. For this reason, even when an attempt is made to bend the substrate portion 53 by tilting the operating portion 54, the flux interferes with the bending of the substrate portion 53. Consequently, the substrate portion 53 cannot be smoothly bent, and the resistances of the strain gauges 53a may properly change.

In order to overcome the above problem, the flux flowing between the printed board 51 and the substrate portion 53 has been removed by subjecting the entire coordinate input device including the printed board 51 to water cleaning by a water cleaning machine.

However, such a process of removing the flux, for example, a water cleaning process is added in the above coordinate input device, the number of manufacturing processes increases, and the cost also increases.

Moreover, since the required cleaning machine is expensive, the cost is increased further.

### SUMMARY OF THE INVENTION

The present invention has been made in view of the above problems, and an object of the invention is to provide a coordinate input device that can reduce the cost by omitting a flux cleaning process.

In order to achieve the above object, the present invention provides a coordinate input device including a flat substrate portion, a plurality of stain gauges formed on one surface of the substrate portion, a columnar operating portion disposed on the other surface of the substrate portion, and a printed board on which one surface of the substrate portion is mounted, wherein a through hole is formed through a portion of the printed board opposing the strain gauges.

In this case, since the portion of the printed board opposing the strain gauges is opened, even when the flux flows to the strain gauges during soldering, the substrate portion can be reliably bent by tilting the operating portion. Consequently, flux cleaning is unnecessary, the assembly time is shortened, and the cost is reduced.

Moreover, since an expensive flux cleaning machine is unnecessary, the cost can be further reduced.

Preferably, the through hole has a size corresponding to the total size of the strain gauges.

In this case, the portion of the printed board opposing the strain gauges can be widely opened. This makes it possible to reliably prevent the flux from flowing to the strain gauges, and to reliably omit the flux cleaning process.

Moreover, even when the substrate portion is greatly bent downward by applying a vertical load to the operating portion, the bent portion of the substrate portion will not touch the printed board. This makes it possible to properly bend the substrate portion in accordance with the operating load, and to precisely change the resistances of the strain gauges.

Preferably, the through hole is formed corresponding to each of the strain gauges. Therefore, the flow of the flux can be prevented by each through hole.

Further, a plurality of small through holes corresponding to the strain gauges can ensure a higher strength of the printed board than one large through hole. This allows the substrate portion to be reliably bent.

Preferably, the substrate portion has through holes formed between the strain gauges. In this case, the through holes can prevent the flux from flowing to the strain gauges, and flux cleaning can be omitted.

Since the substrate portion has the through holes, it can be reliably bent even when a light operating load is applied to the operating portion. For this reason, the ease of operation of the coordinate input device is enhanced.

The present invention also provides a coordinate input device including a flat substrate portion, a plurality of stain gauges formed on one surface of the substrate portion, a columnar operating portion disposed on the other surface of the substrate portion, and a printed board on which one surface of the substrate portion is mounted, wherein a counterbore having a predetermined depth is formed in a portion of the substrate portion on which the strain gauges are formed or/and a portion of the printed board opposing the strain gauges.

In this case, the flux can be prevented from flowing by the counterbore, and flux cleaning can be omitted.

The counterbore can ensure a higher strength of the substrate portion or the printed board than a through hole, and therefore, the substrate portion can be reliably bent in response to the tilting of the operating portion.

Preferably, the counterbore formed in the printed board has a size corresponding to the total size of the strain gauges. This reliably prevents the flux from flowing to the strain gauges.

Preferably, the counterbore is formed in the printed board corresponding to each of the strain gauges. Therefore, the flow of the flux can be prevented by each through hole.

Preferably, the depth of the counterbore formed in the substrate portion or/and the printed board is determined so that the distance between the surfaces of the strain gauges and the printed board is 0.3 mm or more. Therefore, the flow of the flux can be reliably prevented by the counterbore, and flux cleaning can be omitted.

The present invention further provides a coordinate input device including a flat substrate portion, a plurality of stain gauges formed on one surface of the substrate portion, a columnar operating portion disposed on the other surface of the substrate portion, and a printed board to which one surface of the substrate portion is soldered, wherein a plurality of wiring patterns and a resist film for covering the wiring patterns are formed on the surface of a base of the printed board, and portions of the base opposing the strain gauges are exposed without forming the wiring patterns and the resist film thereon.

In this case, the distance between the strain gauges and the printed board can be increased, the flux can be prevented from flowing between the strain gauges and the printed board during soldering, and flux cleaning can be omitted.

Further objects, features and advantages of the present invention will become apparent from the following description of the preferred embodiments with reference to the attached drawings.

### BRIEF DESCRIPTION OF THE DRAWINGS

FIG. 1 is a perspective view of a coordinate input device according to the present invention;

FIG. 2 is an exploded perspective view showing the principal part of the coordinate input device shown in FIG. 1;

FIGS. 3A, 3B, and 3C are explanatory views of a control member in the coordinate input device;

FIG. 4 is a sectional view of the principal part of the coordinate input device;

FIG. 5 is a detailed view of the coordinate input device shown in FIG. 4;

FIGS. 6A and 6B are schematic views showing the operation of the coordinate input device;

FIG. 7 is a sectional view showing the principal part of a modification of the present invention;

FIGS. 8A and 8B are explanatory views of a control member in another modification of the present invention;

FIG. 9 is a sectional view showing the principal part of a further modification of the present invention;

FIG. 10 is a sectional view showing the principal part of a still further modification of the present invention;

FIG. 11 is a sectional view showing the principal part of a yet still further modification of the present invention;

FIG. 12 is a sectional view showing the principal part of a yet still further modification of the present invention; and

FIG. 13 is a sectional view showing the principal part of a known coordinate input device.

### DESCRIPTION OF THE PREFERRED EMBODIMENTS

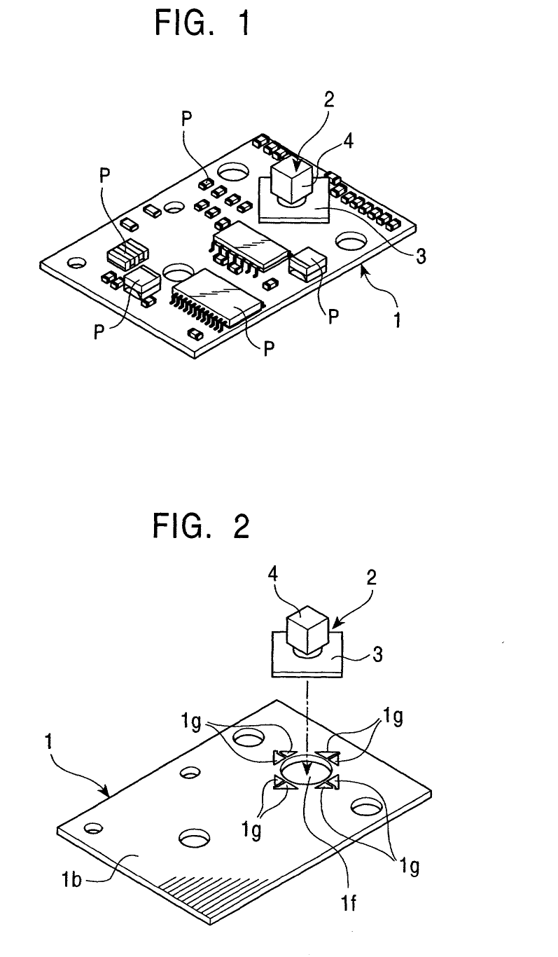

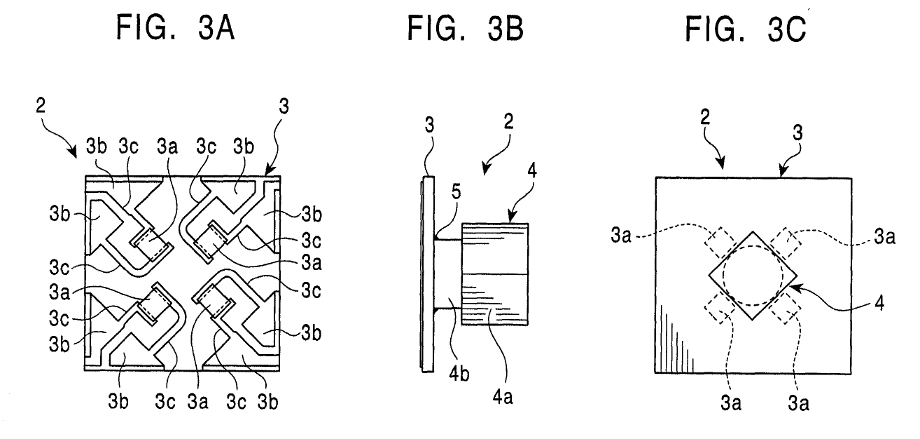

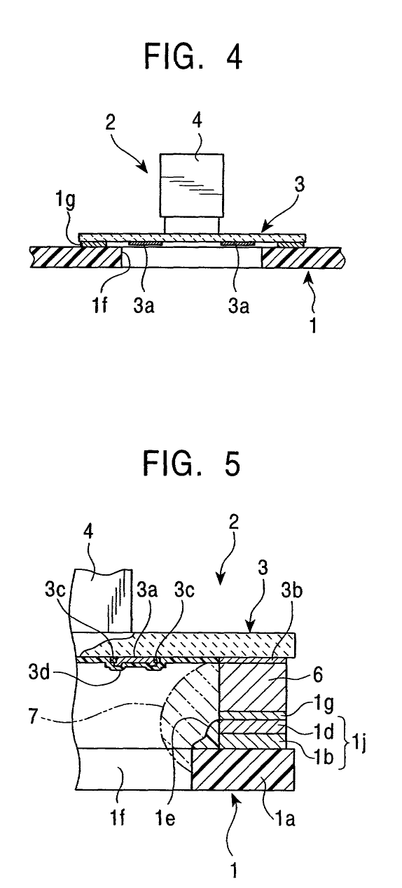

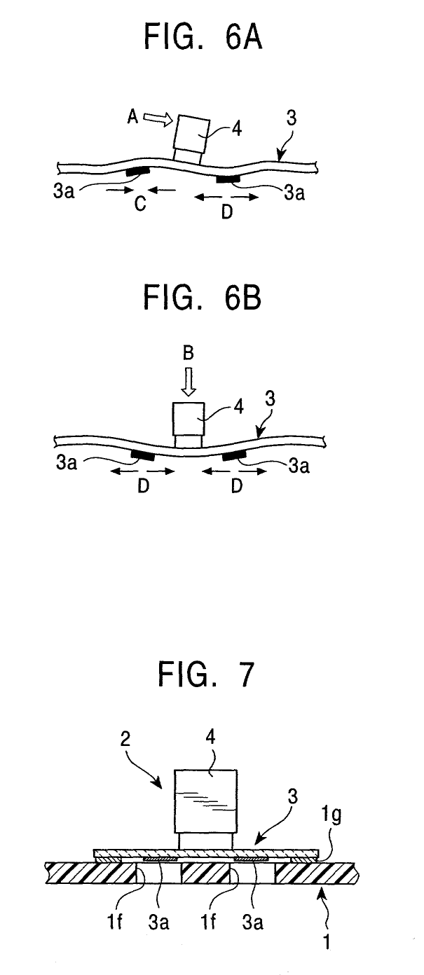

FIG. 1 is a perspective view of a coordinate input device according to an embodiment of the present invention, FIG. 2 is an exploded perspective view showing the principal part of the coordinate input device shown in FIG. 1, FIGS. 3A, 3B, and 3C are explanatory views of a control member in the coordinate input device, FIG. 4 is a sectional view of the principal part of the coordinate input device, FIG. 5 is a detailed view of the coordinate input device shown in FIG. 4, FIGS. 6A and 6B are schematic views showing the operation of the coordinate input device, and FIGS. 7 to 12 are explanatory views showing modifications of the present invention.

A coordinate input device according to the present invention is mounted on a keyboard device of a personal computer or the like. By operating the coordinate input device, a cursor or the like can be moved to an arbitrary position on the display.

A coordinate input device according to an embodiment of the present invention will be described with reference to FIGS. 1 to 5. A printed board 1 is mounted in a keyboard device (not shown) of a personal computer or the like.

In the printed board 1, as shown in FIG. 5, the surface of a base 1a made of, a glass-containing epoxy resin is covered with a conductive film 1b made of copper foil. A copper plating film 1d is formed on the conductive film 1b.

Wiring patterns 1j are formed in a desired pattern by subjecting the conductive film 1b and the copper plating film 1d to, for example, etching using photolithography. The base 1a is exposed outside the wiring patterns 1j made of the conductive film 1b and the copper plating film 1d.

Land portions 1g are connected to the wiring patterns 1j so that a control member 2, which will be described later, is soldered thereon.

In order to enhance solderability of the land portions 1g, the surfaces of the land portions 1g are treated by a solder leveler.

The base 1a including the wiring pattern 1j outside the land portions 1g is covered with a resist film 1e. That is, the land portions 1g are not covered with the resist film 1e, but are exposed.

As shown in FIG. 2, a through hole 1f is formed near the end of the print board 1. The through hole if has a size corresponding to the total size of the strain gauges 3a formed on the below-described control member 2.

Four pairs of land portions 1g are arranged around the through hole 1f, and are equally spaced 90° in the circumferential direction. The land portions 1g are connected to the wiring patterns 1j formed of the conductive film 1b and the copper plating film 1d shown in FIG. 5.

Multiple electronic parts P, such as chip resistors, chip capacitors, and semiconductors, are surface-mounted on land portions (not shown) connected to a plurality of wiring patterns 1j.

The control member 2 is soldered to the land portions 1g arranged around the through hole 1f. As shown in FIG. 3, the control member 2 has a rectangular substrate portion 3. A plurality of (four) strain gauges 3a are formed on one surface of the substrate portion 3 by printing or by other means, as shown in FIG. 3A. The strain gauges 3a are made of a heat-resistant cermet resistor, and variations in resistance thereof are adjusted by laser trimming.

The strain gauges 3a are equally spaced 90° in the circumferential direction. A pair of electrode portions 3b made of silver palladium are formed at each corner of the substrate portion 3 so that they can be soldered to the land portions 1g of the print board 1.

Patterns 3c made of the same material as that of the electrode portions 3b extend from the electrode portions 3b. The strain gauges 3a are printed on the patterns 3c, thereby connecting the electrode portions 3b and the strain gauges 3a.

A protective layer 3a is formed on the strain gauges 3a and the patterns 3c except for the electrode portions 3b, as shown in FIG. 5.

An operating portion 4 shaped like a rectangular column is placed at about the center of the rectangular substrate portion 3. The operating portion 4 includes a columnar portion 4a shaped like, for example, a quadrangular column shown on the right side of FIG. 3B, and a cylindrical portion 4b shown on the left side. The cylindrical portion 4b is bonded to about the center of the substrate portion 3 with an adhesive 5, so that the substrate portion 3 and the operating portion 4 are combined.

The adhesive 5 is, for example, a heat-resistant and thermosetting epoxy resin.

The columnar portion 4a is covered with a piled cap or the like (not shown) so that an operator can easily operate the operating portion 4a with the operator's fingers or the like.

Since the portion of the operating portion 4 that is bonded to the substrate portion 3 is cylindrical, the substrate portion 3 can be bent with high precision by applying an operating load from any horizontal direction.

The substrate portion 3 and the operating portion 4 are made of a heat-resistant ceramic material, such as alumina. The ceramic material has a superior temperature characteristic, and rarely expands or shrinks even when the environmental temperature changes substantially. The control member 4 may be made of metal.

As shown in FIG. 5, the control member 2 is mounted on the printed board 1 by soldering the electrode portions 3b to the land portions 1g with a solder cream 6.

A description will be given of how to assemble the above-described coordinate input device of the present invention.

First, solder cream 6 is applied onto necessary portions such as the land portions 1g and other land portions (not shown) connected to the wiring patterns 1j.

Then, multiple electronic parts P are placed on predetermined positions of the wiring patterns 1j, and the control member 2 is placed on the through hole 1f while the electrode portions 3b thereof are aligned with the land portions 1g formed around the through hole 1f.

Next, the printed board 1 having the control member 2 and the electronic parts P placed thereon is passed through a high-temperature soldering furnace for reflow soldering. Consequently, the solder cream 6 is melted, and the control member 2 and the electronic parts P are thereby soldered to the printed board 1.

In this case, flux 7 contained in the solder cream 6 is melted into a liquid form due to high temperature, and flows between the printed board 1 and the substrate portion 3 shown in FIG. 5.

However, the flux 7 does not reach any strain gauge 3a because of the existence of the through hole 1f.

Even if the flux 7 flows to the strain gauge 3a, the portion of the printed board 1 opposing the strain gauge 3a is opened by the through hole 1f.

For this reason, the substrate portion 3 can be properly bent, and the resistances of the strain gauges 3a can be precisely changed by operating the operating portion 4.

As a result, the coordinate input device of the present invention need not be subjected to flux cleaning after soldering. This shortens the assembly time.

A method for operating the coordinate input device thus surface-mounted and assembled will now be described. First, as shown in a schematic view of FIG. 6A, the operating portion 4 is tilted to the right in the figure by applying thereto a load in the horizontal direction shown by arrow A.

Then, the substrate portion 3 fixedly soldered to the land portions 1g of the printed board 1 is bent in an undulatory form.

The strain gauge 3a on the left side of the figure is compressed in the direction shown by arrow C by the bending, and the resistance thereof becomes lower than the initial value.

The strain gauge 3a on the right side is pulled in the direction shown by arrow D, and the resistance thereof becomes higher than the initial value.

The amount of change in resistance between the right and left strain gauges 3a is detected and calculated by, for example, a control section formed of a semiconductor among the electronic parts P. The control section controls the movement of, for example, a cursor on the display of a personal computer in accordance with the amount of change in resistance.

When a load in the vertical direction shown by arrow B is applied to the operating portion 4, as shown in FIG. 6B, the four strain gauges 3a are substantially equally pulled in the direction shown by arrow D, and the resistances thereof increase from the initial values.

When the control section detects that the resistances of all the strain gauges 3a increase, the position of the cursor can be determined.

While one through hole 1f having a size corresponding to the total size of the strain gauges 3a is formed in the printed board 1 of the coordinate input device of the present invention, for example, four through holes 1f may be formed at the positions respectively opposing the strain gauges 3a, as shown in FIG. 7.

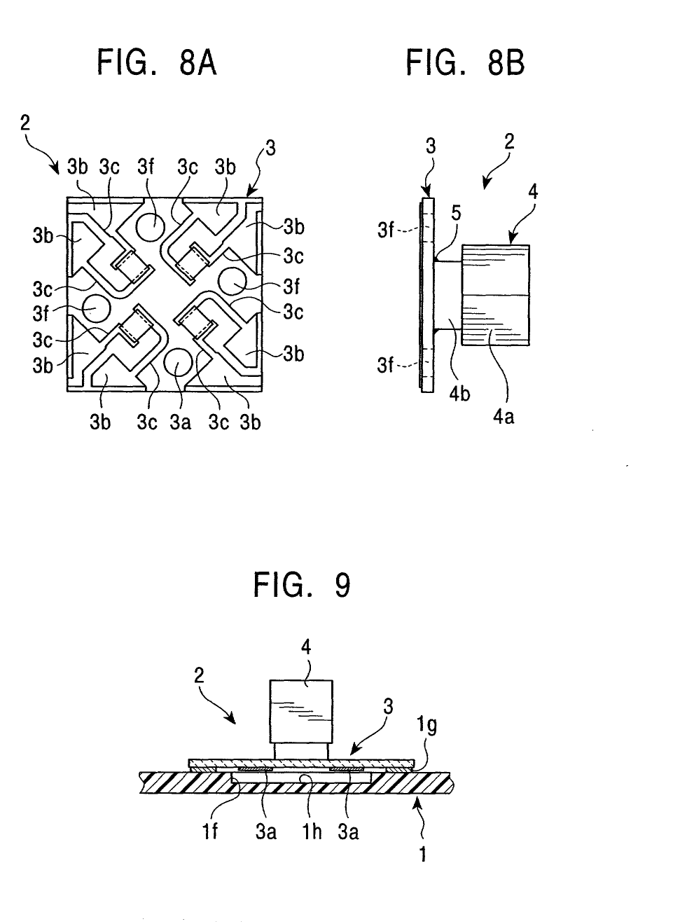

As a modification, the through holes 1f formed in the printed board 1 shown in FIGS. 4 and 7 and a plurality of through holes 3f formed in the substrate portion 3 of the control member 2 shown in FIGS. 8A and 8B may be combined.

The through holes 3f are formed through the substrate portion 3 placed between the strain gauges 3a, as shown in FIG. 8A.

By thus forming the through holes 1f and 3f in the printed board 1 and the substrate portion 3, respectively, the flux 7 can be more reliably prevented from flowing to the strain gauges 3a.

The printed board 1 may be provided with a counterbore 1h having a predetermined depth that is formed at the same position as that of the through hole 1f shown in FIG. 4 or 7 and that has the same size as that of the through hole 1f.

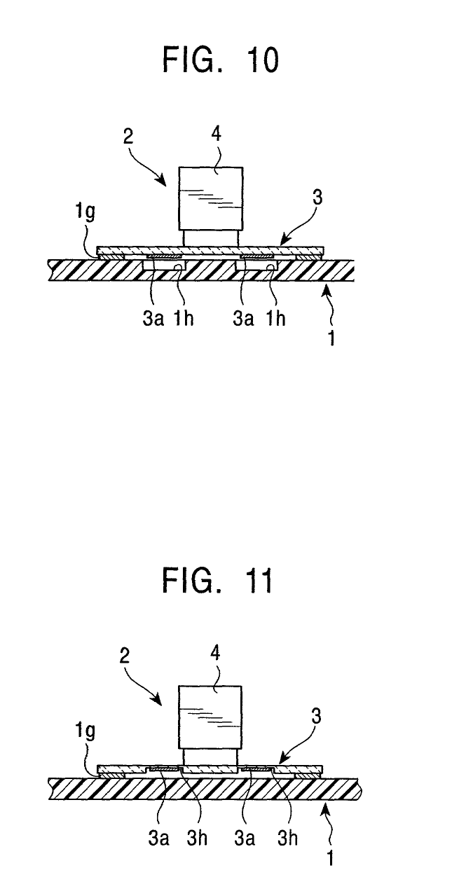

That is, one counterbore 1h having a size corresponding to the total size of the strain gauges 3a may be formed, as shown in FIG. 9, or a plurality of counterbores 1h may be formed opposed to the strain gauges 3a, as shown in FIG. 10. Each case can provide the same advantages of the through hole 1f or the through holes 1f.

Instead of forming the through hole 1f or the counterbore 1h in the printed board 1, counterbores 3h having a predetermined depth may be formed at the positions of the substrate portion 3 corresponding to the strain gauges 3a, and the strain gauges 3a may be placed on the bottom faces of the counter bores 3h, as shown in FIG. 11.

The depths of the counterbore 1h of the printed board 1 and the counterbores 3h of the substrate portion 3 are determined so that the distance between the strain gauges 3a and the printed board 1 is 0.3 mm or more.

That is, in a case in which the counterbore 1h or the counterbores 1h are formed in the printed board 1, as shown in FIG. 9 or 10, the distance between the strain gauges 3a and the bottom surface of the counterbore 1h or the counterbores 1h is 0.3 mm or more.

For this reason, the flux 7 will not flow to the strain gauges 3a during soldering.

Both the counterbores 1h and 3h may be formed in the printed board 1 and the substrate portion 3, respectively.

That is, the counterbores 1h or/and the counterbores 3h having a predetermined depth may be formed in the substrate portion 3 having the strain gauges 3a or/and in the printed board 1 opposing the strain gauges 3a.

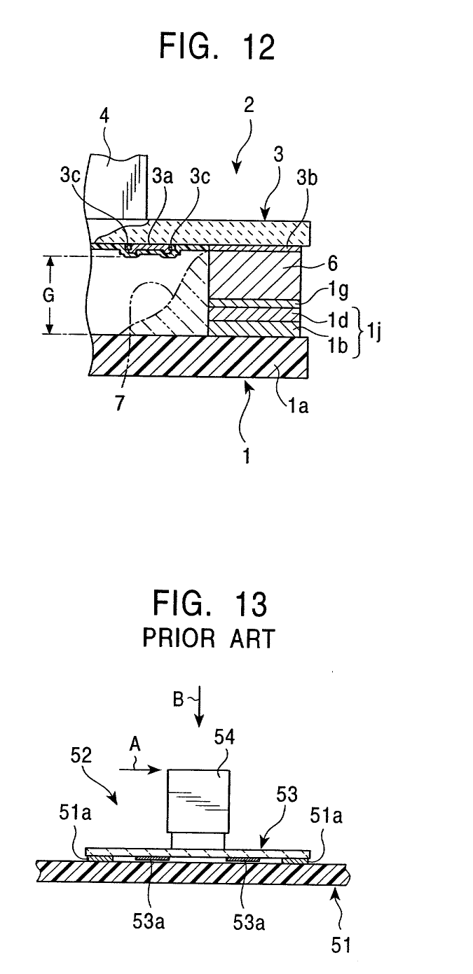

As shown in FIG. 12, another structure may be adopted in which a plurality of wiring patterns 1j and a resist film 1e covering the wiring patterns 1j are formed on the surface of the base 1a of the printed board 1, and the portions of the printed board 1 opposing the strain gauges 3a are exposed without the wiring patterns 1j and the resist film 1e.

In such a coordinate input device, the gap G between the strain gauges 3a and the base 1a of the printed board 1 can be increased, and the flow of the flux during soldering can be stopped between the substrate portion 3 of the control member 2 and the base 1a of the printed board 1.

The shape of the above-described through holes 1f and 3f or the counterbores 1h and 3h is not limited to a circle, and may be a different shape such as a triangle.

While the substrate portion 3 and the operating portion 4 are bonded with the adhesive 5 in the above description, they may be integrally formed.

While the substrate portion 3 is made of alumina that has a superior temperature characteristic, it may be made of other materials similarly having a superior temperature characteristic, for example, glass.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A coordinate input device comprising:
a flat substrate portion;
a plurality of stain gauges formed on one surface of said substrate portion;
a columnar operating portion disposed on the other surface of said substrate portion; and
a printed board on which said one surface of said substrate portion is mounted,
wherein a through hole is formed through a portion of said printed board opposing said strain gauges.

2. A coordinate input device according to claim 1, wherein said through hole has a size corresponding to the total size of said strain gauges.

3. A coordinate input device according to claim 1, wherein said through hole is formed corresponding to each of said strain gauges.

4. A coordinate input device according to claim 1, wherein said substrate portion has through holes formed between said strain gauges.

5. A coordinate input device comprising:
a flat substrate portion;
plurality of stain gauges formed on one surface of said substrate portion;
a columnar operating portion disposed on the other surface of said substrate portion; and
a printed board on which said one surface of said substrate portion is mounted,
wherein a counterbore having a predetermined depth is formed in a portion of said substrate portion on which said strain gauges are formed or/and a portion of said printed board opposing said strain gauges.

6. A coordinate input device according to claim 5, wherein said counterbore formed in said printed board has a size corresponding to the total size of said strain gauges.

7. A coordinate input device according to claim 5, wherein said counterbore is formed in said printed board corresponding to each of said strain gauges.

8. A coordinate input device according to claim 5, wherein the depth of said counterbore formed in said substrate portion or/and said printed board is determined so that the distance between the surfaces of said strain gauges and said printed board is 0.3 mm or more.

9. A coordinate input device comprising:
a flat substrate portion;
plurality of stain gauges formed on one surface of said substrate portion;
a columnar operating portion disposed on the other surface of said substrate portion; and
a printed board to which said one surface of said substrate portion is soldered,
wherein a plurality of wiring patterns and a resist film for covering said wiring patterns are formed on the surface of a base of said printed board, and portions of said base opposing said strain gauges are exposed without forming said wiring patterns and said resist film thereon.
